(19) United States
(12) Patent Application Publication
(10) Pub. No.: US 2003/0187876 A1
(43) Pub. Date: Oct. 2, 2003

(54) Office counter work supporting system

(75) Inventor: Shinichi Ohnishi, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/391,013

(22) Filed: Mar. 19, 2003

(30) Foreign Application Priority Data
Mar. 29, 2002 (JP) 2002-094833

(51) Int. Cl. G06F 17/00

(52) U.S. Cl. 707/104.1

(57) ABSTRACT

An office counter work supporting system includes a sales office system with a counter terminal operated by an operator, and a supporting center system with a database to store information which is collected via multiple channels and a server to generate office counter work supporting information based on the information stored in the database, which is connected via a network to the sales office system. Various information on each customer that is collected via various channels, and information on services and products corresponding to the above information can be properly supplied to an operator to support the operator's office counter work.

### BACKGROUND OF THE INVENTION

1. Field of the Invention

The present invention relates to an office counter work supporting system.

2. Description of the Related Art

Heretofore, if a customer visits a bank or an office which performs work at an office counter, he/she takes a numbered ticket with a receipt number from a ticketing machine, and waits for his/her receipt number to be called. When his/her receipt number is called, he/she goes to a designated counter where he/she is accepted for a requested procedure.

Thanks to the above method, a customer can wait for his/her turn at a seat in a waiting area without making a line at a counter, and he/she does not become fatigued. If the number of people on the waiting list and a service number at a counter are displayed in a display device, a customer can estimate his/her waiting time to a degree and does not feel inner stress.

Since an operator at a counter will not be asked about a length of waiting time by a customer, and can devote himself/herself to his/her work, the efficiency of such office counter work will be improved.

In recent years, services and goods offered by a company have become diverse, and answering various inquiries and consultations from a customer at a counter and explaining actively the services and the goods to a customer are demanded as part of counter office work. However, a system to sufficiently support such office counter work has not been provided.

For example, at a counter of a financial institution such as a bank, a terminal of a business system is allocated for an operator to conduct an office counter work. But the business system is specialized in banking action such as funds transfer, which is an account action and not in support of other work. In financial institutions, services and products have recently upgraded, and new products such as an investment trust, insurance, and 401K type annual pensions have been introduced. However, if an operator replies to or explains the new products to a customer, he/she cannot get any information about the products by operating the above business system, which causes the operator difficulties in sufficiently performing his/her job. Recently, in order to accept and reply to inquiries and consultancies on services and products offered by a company, a call center that accepts telephone inquiries is usually established. A call center responds to telephone inquiries and consultancies from customers referring to various materials which describe business contents, services, and explanations of products of the company according to the inquiries and consultancies.

Due to the advances of the IT (Information Technology) and the spread of the Internet, inquiries and consultancies by electronic mail or information on a website of the Internet have rapidly increased. As for the above inquiries and consultancies from customers, electronic mail for replies and replies on the web pages are utilized.

However, information, experiences, and technique stored from handling customers through various channels such as a call center, electronic mail, and the Internet are not reflected to office counter work which is the most important in the view point of directly treating customers. This makes it difficult for an operator to sufficiently meet with each customer's needs and deal with them properly.

### SUMMARY OF THE INVENTION

One object of the present invention is to provide a office counter work supporting system that can support an operator in his/her office counter work by properly providing to the operator various information on each customer collected via various channels and then stored, and information on services and products corresponding to the above information.

The office counter work supporting system according to the present invention comprises an sales office system including a counter terminal operated by an operator and a support center system including a database to store information collected from multiple channels and a server to generate office counter work supporting information based on the information stored in said database, the support center being connected via a network to said office system.

In another office counter work supporting system according to the present invention, the sales office system additionally has a reception terminal operated by a customer, and the support center system generates a message used to guide the customer, and transmits the message to the reception terminal so that the reception terminal displays the message.

In another office counter work supporting system according to the present invention, the support center system generates office counter work supporting information based on information received from the counter terminal, and transmits the office counter work supporting information to the counter terminal so that the counter terminal displays the office counter work supporting information.

In another office counter work supporting system according to the present invention, the network is connected with a contact center, and the support center system connects the contact center to said counter terminal in accordance with information received from the counter terminal.

In another office counter work supporting system according to the present invention, the multiple channels include the counter terminal, the reception terminal, a call center connected to the network and a contact center connected to the network.

In another office counter work supporting system according to the present invention, the information stored in the database includes customer attribute information, sales action information for the customer, and operator attribute information.

In another office counter work supporting system according to the present invention, the server generates the office counter work supporting information in accordance with the customer attribute information, the sales action information for the customer, or the operator attribute information.

In the database for the office counter work supporting system according to the present invention, the support center system is connected via a network to an office system, and the office system includes a counter terminal operated by an operator, and wherein said database stores first information to generate office counter work supporting information and second information collected from multiple channels.

In the database for another office counter work supporting system according to the present invention, the information includes customer attribute information, sales action information for a customer information, and operator attribute information.

In the database for another office counter work supporting system according to the present invention, the multiple channels include the counter terminal, a reception terminal, a call center connected to the network and a contact center connected to the network.

In the counter terminal of the office counter work supporting system according to the present invention, the support center system includes a database to store information collected from multiple channels and a server to generate office counter work supporting information based on said information stored in said database, and the counter terminal is operated by an operator to receive and display the office counter work supporting information.

### BRIEF DESCRIPTION OF THE DRAWINGS

FIG. 1 shows a configuration of an office counter work supporting system according to the first embodiment of the present invention.

FIG. 2 shows a configuration of a mini MCIF server according to the first embodiment of the present invention.

FIG. 3 shows a schematic diagram of a configuration of a counter terminal according to the first embodiment of the present invention.

FIG. 4 shows an operation of the office counter work supporting system to guide a customer according to the first embodiment of the present invention.

FIG. 5 shows an operation of the system when an operator receives advice according the first embodiment of the present invention.

FIG. 6A shows screen contents including sales assistant information according to the first embodiment of the present invention.

FIG. 6B shows screen contents including sales assistant information according to the first embodiment of the present invention.

FIG. 6C shows screen contents including sales assistant information according to the first embodiment of the present invention.

FIG. 6D shows screen contents including sales assistant information according to the first embodiment of the present invention.

FIG. 7 shows an operation of the system when an operator receives advice according to the second embodiment of the present invention.

FIG. 8 shows screen contents including sales assistant information according to the second embodiment of the present invention.

FIG. 9 shows an operation of the system when an operator receives advice according to the third embodiment of the present invention.

FIG. 10 shows screen contents including sales assistant information according to the third embodiment according of the present invention.

FIG. 11 shows remote sales according to the forth embodiment of the present invention.

FIG. 12A shows a series of operations including remote sales according to the forth embodiment of the present, invention.

FIG. 12B shows a series of operations including remote sales according to the forth embodiment of the present invention.

FIG. 12C shows a series of operations including remote sales according to the forth embodiment of the present invention.

FIG. 13A shows a series of operations including remote sales according to the fifth embodiment of the present invention.

FIG. 13B shows a series of operations including remote sales according to the fifth embodiment of the present invention.

FIG. 13C shows a series of operations including remote sales according to the fifth embodiment of the present invention.

FIG. 14 shows an operation of the system when an operator receives advice according to the sixth embodiment of the present invention.

FIG. 15 shows screen contents including sales assistant information according to the sixth embodiment of the present invention.

FIG. 16 shows an operation of the system when an operator receives advice according to the seventh embodiment of the present invention.

FIG. 17 shows an operation of the system when an operator receives advice according to the eighth embodiment according of the present invention.

FIG. 18 shows an operation of the system when an operator receives advice according to the ninth embodiment of the present invention.

FIG. 19 shows screen contents including sales assistant information according to the ninth embodiment of the present invention.

FIG. 20 shows an operation of the system when an operator logs onto the CI server according to the ninth embodiment of the present invention.

### DETAILED DESCRIPTION OF THE INVENTION

Embodiments of the present invention will be described in reference to the accompanying drawings.

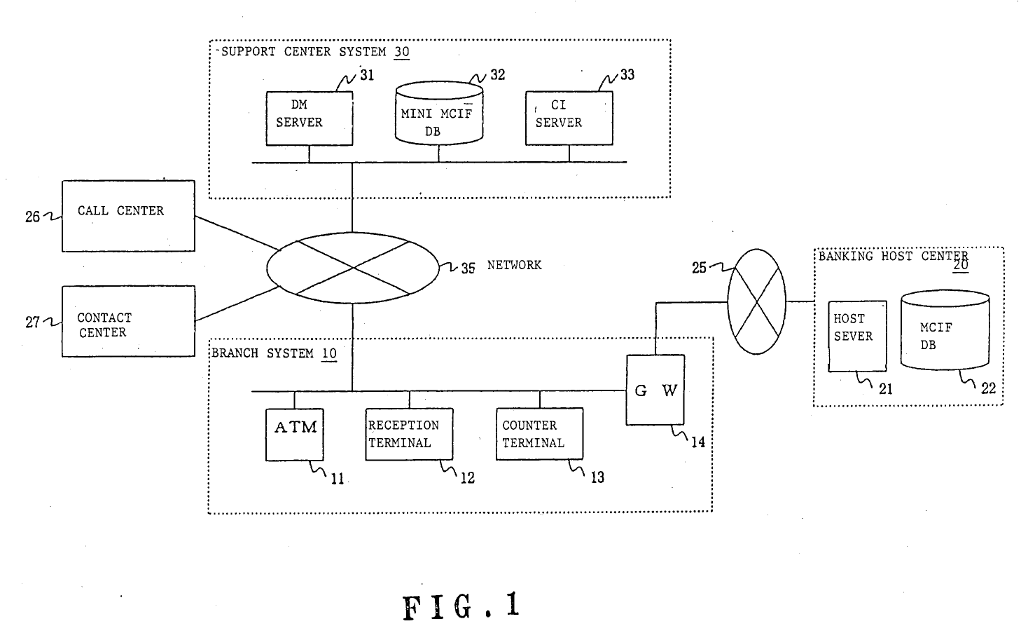

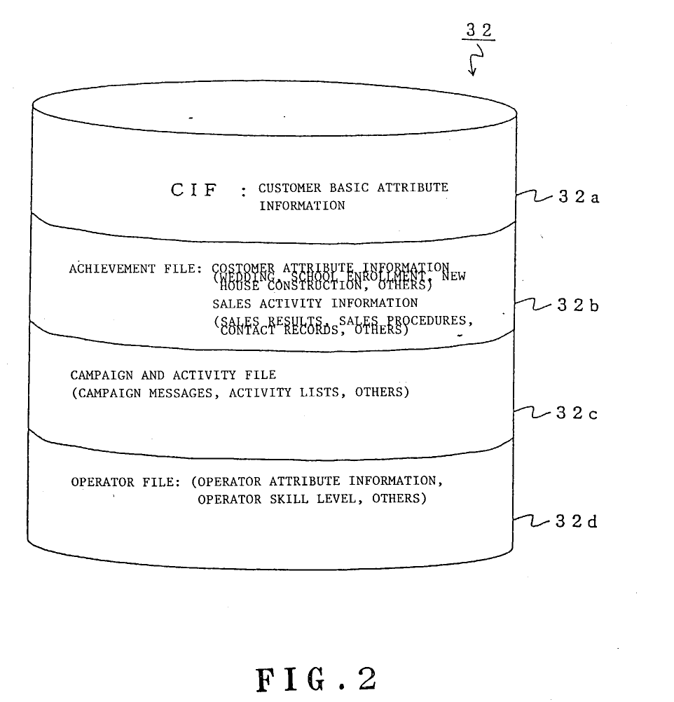

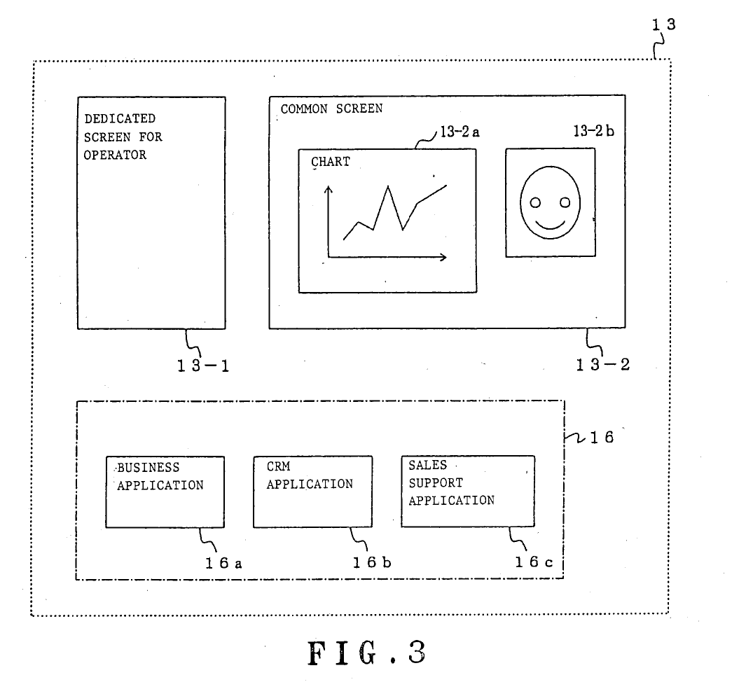

FIG. 1 shows an office counter work supporting system according to the first embodiment of the present invention. FIG. 2 shows a mini MCIF server used in the supporting system shown in FIG. 1. FIG. 3 shows a schematic diagram of a configuration of a counter terminal used in the supporting system shown in FIG. 1.

Referring to FIG. 1, reference numeral 10 designates an office system (computer system) provided in a facility such as office sales counter and a store to which a customer visits. In this embodiment, the sales office may be an office of various companies or organizations that receive customers for sales and marketing, and may be any kind of business such as financial institutions, a brokerage, an insurance company, a manufacturing or sales company selling any type of product or service, such as computers, software, vehicles, electrical and electronic devices, department store and supermarket, hotels and inns, and transportation companies. Hereafter, for explanation purpose only, an example will be given where the branch office is a financial institution such as a bank or credit association.

The sales office system 10 has an ATM (Automatic Teller Machine) 11, an reception terminal 12, a counter terminal 13, and a gateway 14. The ATM 11 is a device that a customer of a financial institution operates by himself/herself so as to handle accounts such as deposits, withdrawals, money transfer, and bankbook entry. In this embodiment, the ATM 11 also includes a CD (Cash Dispenser). The reception terminal 12 is a computer allocated around the entrance to a sales office, and logic units such as a CPU and a MPU, a memory such as a magnetic disk and a semiconductor memory, an input such as a keyboard and a touch panel, a display such as a CRT and a liquid crystal display (LCD), an audio output such as a speaker, a communication interface, and a ticketing module to issue a numbered ticket. Before visiting a counter in a sales office, a customer operates the reception terminal 12 by himself/herself to input his/her business, address, and name. Then, the counter number for his/her business, his receipt number, and an estimated waiting time are output from the display, audio, and the ticketing module. If a customer has a cash card or a bankbook, a magnet stripe reader (not shown) can scan information stored in a magnetic stripe of the cash card or the bankbook, and does not need to input his/her address and name.

The counter terminal 13 is a computer equipped with logic units such as an CPU and an MPU, a memory such as a magnetic disk and a semiconductor memory, an input such as a keyboard, a mouse, and a touch panel, a display such as a CRT and a liquid crystal display (LCD), an audio input such as a microphone, an audio output such as a headphone and a speaker, a communication interface, and a printer. An operator of a sales office or a teller in a bank facility may operate the counter terminal 13 to handle various jobs such as deposits, withdrawals, money transfers, and entry in bankbooks, opening of an account, and setup of a term deposit, and acquires various information, such as the customer's business entered in the reception terminal, the customer's address and name, information on each customer previously collected and stored, information on a new product and a continuing on new campaign, and guidance on services.

In FIG. 1, the ATM 11, the reception terminal 12, and the counter terminal 13 are respectively shown by single items, but a plurality of such items may be provided. The ATM 11, the reception terminal 12, and the counter terminal 13 are connected with each other.

Reference numeral 20 designates a banking host center as a computer system to perform accounting procedures in a financial institution. The banking host center 20 has a host server 21 including a logic unit such as a CPU and a MPU, a memory such as a magnetic disk and a semiconductor memory, an input such as a keyboard and a mouse, a display such as a CRT and a liquid crystal display (LCD), a communication interface, and a MCIF (Marketing Customer Information File) database 22 comprising a memory device such as a magnetic disk and a semiconductor memory. The host server 21 handles all the account transactions within the financial institution. The MCIF database 22 stores information on basic attributes, such as address, name, age, job, income, and family structure, of each customer of the financial institution, that is, customer basic attribute information, and account transaction information such as records of past account transactions.

The banking host center 20 is connected to a network 25, to which the sales office system 10 is connected via the gateway 14. The network 25 can be a radio wireless transmission or a wired network such as a public telecommunication network and a private telecommunication network, the Internet, a LAN (Local Area Network), a WAN (Wide Area Network), and so on. The network 25 preferably is a private network, but may be a VPN (Virtual Private Network) utilizing a public switched telephone network.

Reference numeral 30 designates a computer support center system, which has a database to store information collected via multiple channels, and a server to generate office counter work supporting information based on the information stored in the database. The database is a mini MCID database 32 which includes a memory such as a magnetic disk and a semiconductor memory, and the server is a CI (Channel Interaction) server equipped with a logic unit such as a CPU and an MPU, a memory such as a magnetic disk and a semiconductor memory, an input such as a keyboard and a mouse, a display such as a CRT and a liquid crystal display (LCD), and a communication interface. The DM server 31 and the CI server 33 can be integrated.

The mini MCIF database 32, as shown in FIG. 2, has a CIF (Customer Information File) 32a, an achievement record file 32b, a campaign and action file 32c, and an operator file 32d. The CIF 32a stores customer basic attribute information on each customer, which is periodically updated by information stored in the MCIF database 22. In other words, a batch processing replicates customer basic attribute information stored in the MCIF database 22 to update the customer basic attribute information stored in the CIF 32a.

The actual sales record file 32b stores customer attribute information collected via various channels for collecting information such as information on each customer which is collected at the call center 26 and the contact center 27, as will hereinafter be described, or collected by an operator at a counter. The actual sales record file 32b also stores sales procedures and results which for each customer by an operator or an agent of a financial institute, and sales action information collected via a channel for collecting various information such as record of contact to each customer from an operator, the call center 26, and the contact center 27.

The campaign and action file 32c stores campaign messages used in a current campaign for a product or a service, and an action list comprising suggestions and advice for a customer. The operator file 32d stores operator attribute information, such as address, name, age, birthday, and employment record of each operator, and information on the experience and skill level of each operator.

The CI server 33 accommodates a CRM (Customer Relationship Management) application to acquire and use various information stored in the mini MCIF database 32, a sales support application to obtain advice, from a supervisor, directions, guidance for a customer, and explanation for an operator by accessing the contact center 27, and other applications to explain and start new products such as an investment trust, insurance, and a 401K type pension.

The DM server 31 analyzes various information stored in the mini MCIF database 32 to generate campaign messages, suggestions, and advice, which are stored in the campaign and action file 32c of the mini MCIF database 32, or transmitted to the CI server 33 to be processed by the above-mentioned applications.

The support center system 30 is connected to the sales office system 10 via the network 35. The network 35 may be a leased line network or a public telecommunication network of the radio or wireless transmission type or a fixed line, the Internet, a LAN, a WAN, a VPN and so on. The network 35 is preferably separate from the network 25.

The network 35 includes the connections to the call center 26 and the contact center 27. The call center 26 accepts inquiries and consultancies by telephone so as to reply to various inquiries and consultancies about services and products offered by the financial institute. The call center 26 collects contents of replies for the inquiries and consultancies as well as customer basic attribute information of a customer who has made an inquiry or consultation by telephone, and transmits the attribute information to the support center system 30. Thus, the achievement record file 32b in the mini MCIF data base 32 stores and accumulates the customer attribute information and the sales action information collected by the call center 26.

The contact center 27 is an operator center for an operator at a counter if he/she needs expertise, advice, and detailed explanation in dealing with a customer. A supervisor with expertise and experiences on services and products offered by the financial institute operates a terminal (not shown) to give advice, explanations, directions, and guidance to the operator or make explanations to the customer. Then, the contact center 27 collects records of contacts with the customer and sales procedures and results obtained for a customer via a counter terminal as well as customer basic attribute information, which are transmitted to the support center system 30. Thus, the achievement record files 32b in the mini MCIF database 32 stores the customer attribute information and the sales action information collected by the customer service center 27. Additionally, the customer service center 27 evaluates the skill of an operator based on the guidance such as advice, explanations, and directions to the operator, and transmits the skill evaluation result to the support center system 30. Thus, information on the skill level of the operator stored in the operator file 32d in the mini MCIF database 32 is updated.

In this embodiment, the reception terminal 13 has a display device to display office counter work supporting information, which includes a operator-dedicated screen 13-1, and a common screen 13-2 that an operator views with a customer, if needed. The reception terminal 13 can implement various jobs with the software 16. The software 16 includes a business application 16a to implement accounts tasks in the financial institute (i.e. various financial services), a CRM application 16b to acquire and use various information stored in the mini MCIF database 32, and a sales support application 16c to acquire advice, explanations, directions, and guidance to the operator from the supervisor, and explanations to the customer by accessing the customer service center 27. The CRM application 16b and the sales support application 16c may be downloaded from the CI server when needed.

The operator-dedicated screen 13-1 displays, for instance, a screen to implement accounts tasks in the financial institute such as various financial services. The operator-dedicated screen 13-1 also displays various information stored in the mini MCIF database 32. The common screen 13-2 displays data and charts (13-2a) such as graphs and tables used in explanations for a customer by the supervisor in the customer service center 27, and an image of the supervisor 13-2b.

The operation of the office counter work supporting system of the above configuration will be described. Firstly, the operation for a customer guidance will be described.

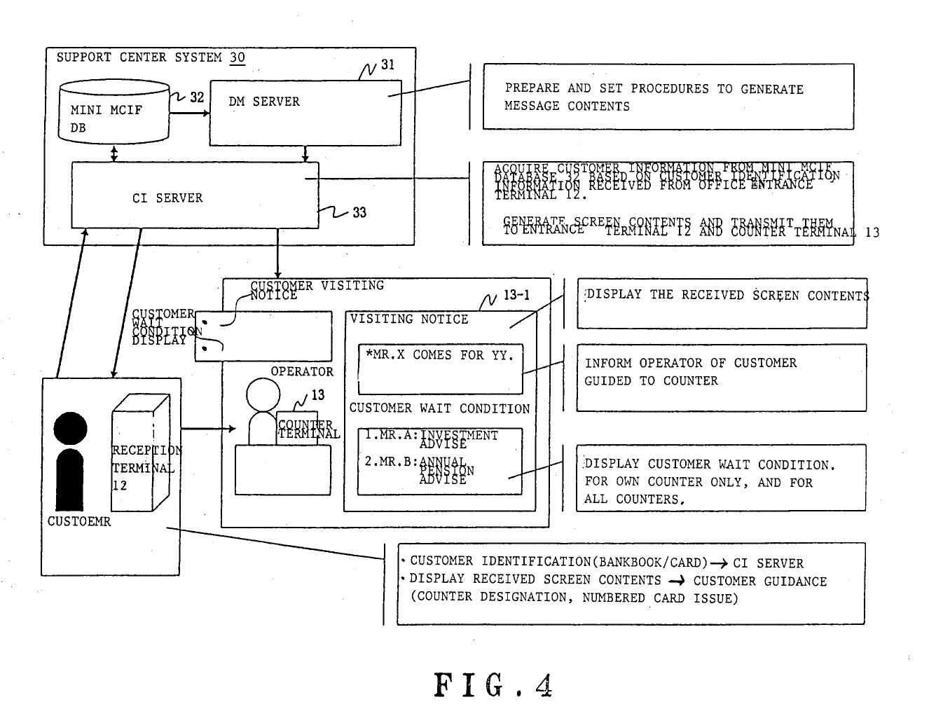

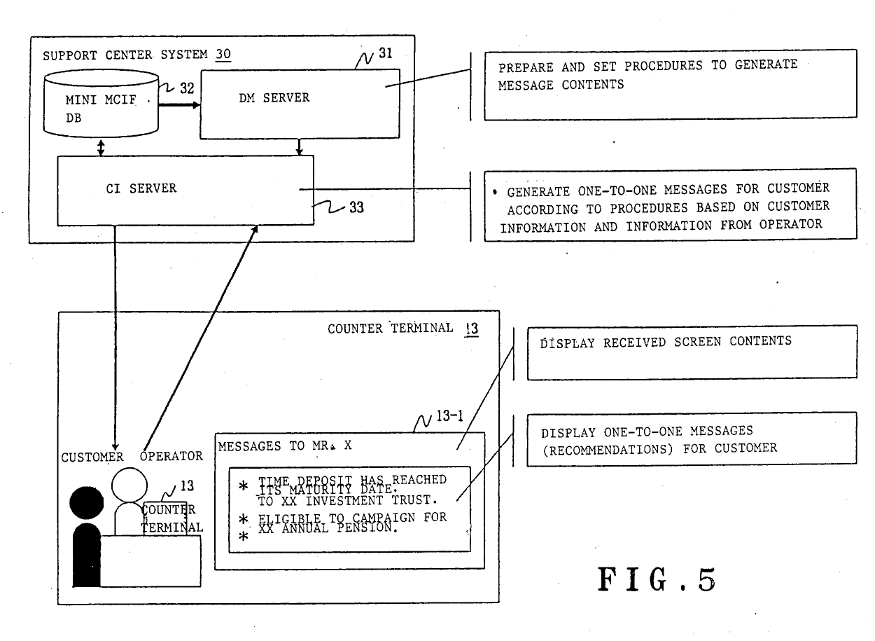

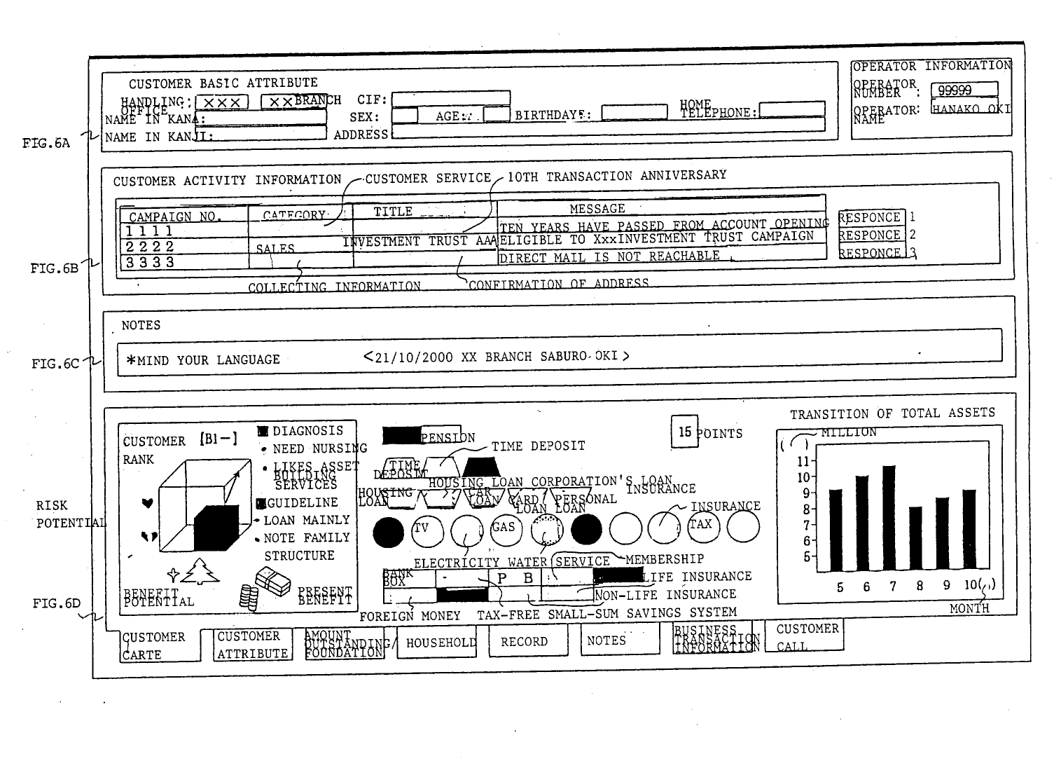

FIG. 4 shows an operation to guide a customer according to the first embodiment of the present invention. FIG. 5 shows an operation in which an operator receives advice according to the first embodiment of the present invention. FIG. 6 shows screen contents including sales assistant information according to the first embodiment of the present invention.

A customer who visits a counter in a sales office, as shown in FIG. 4, operates the reception terminal 12 to input his/her business (the purpose of his/her visit) and a magnet stripe reader (not shown) scans information in a magnetic stripe of a cash card or a bankbook of the customer. The reception terminal 12 acquires customer identification information, such as an account number, to identify a customer from the cash card or bankbook information. The customer identification information is then transmitted to the support center system 30 with the customer's business purpose.

The CI server 33 in the support center system 30 accesses the mini MCIF database 32, from which information on the customer is acquired based on the received customer identification information. The customer information is the customer basic attribute information stored in the CIF 32a and the customer attribute information stored in the achievement record file 32b. Based on the acquired customer information and the customer's business purpose, the CI server 33 generates screen contents including a CI server-to-customer message for the customer according to the procedures previously prepared and set by the DM server 31. The screen contents are transmitted to the reception terminal. Visit records of the customer included in the customer attribute information stored in the achievement record file 32b are also updated.

The reception terminal 12 displays the received screen contents in the display device (not shown) to show the CI server-to-customer message to the customer, and guides the customer to a counter which can answer (deal with) the customer's business purpose, or a counter of a particular operator who is responsible for this particular customer if the operator is available.

The IC server 33, based on the acquired customer information and the customer's business, generates screen contents including a message to the operator according to procedures previously prepared by the DM server 31. The screen contents are transmitted to the counter terminal 13. The counter terminal 13 displays the received screen contents on the operator-dedicated screen 13-1 as shown in FIG. 4. The operator can grasp in advance various information on the customer, who will be guided to the operator's counter, such as the customer's name and purpose of the visit.

The customer waits until the customer's turn. When it's the customer's turn at the counter, the operator assists the customer. At this time, the CI server 33 has already generated screen contents including sales advice for the operator. In this embodiment, the CI server 33 has acquired campaign messages stored in the campaign and action file 32c and an action list including suggestions and advice for the customer as well as the experience and the skill level of the operator previously stored in the operator file 32d. Based on the information, such as the customer information, the business, the action list, and the experience and the skill level of the operator, the CI server 33 generates screen contents including the sales advice for the operator in accordance with the procedures prepared and set by the DM server 31. Here, it is assumed that the screen contents including CI server-to-customer messages as recommendations for the customer are generated.

The screen contents are transmitted to the counter terminal 13. The counter terminal 13 displays the received screen contents on the operator-dedicated screen 13-1 as shown in FIG. 5. Thus, the operator can deliver the CI server-to-customer messages to the customer at the operator's counter.

Then, based on the information, such as the customer information, the customer's business purpose, the action list, and the experience and the skill level of the operator, the CI server 33 generates screen contents including sales assistance information for the operator in accordance with the procedures previously prepared by the DM server 31. The screen contents are then is sent to the counter terminal 13. The counter terminal 13 displays the received screen contents on the operator-dedicated screen 13-1 as shown in FIGS. 6A to 6D.

In this embodiment, the sales assistance information includes the customer basic attribute information shown in FIG. 6A, the action-to-customer information shown in FIG. 6B, the notes shown in FIG. 6C, and the customer record (carte) shown in FIG. 6D. In the action-to-customer information field in the display screen, recommendation messages including the action information, campaign information, and the service message for the customer are displayed. The customer record (carte) field shows information summary required in sales for the customer, customer rank information showing the level of importance in the financial institute, current account information of the customer, and information showing current total assets of the customer are displayed. Thus, the operator can provide proper services and sales for products to the customer by referring to the sales assistance information.

In this embodiment, since an operator can refer to various information about a customer before the customer comes to the counter, the operator can assist the customer more efficiently precisely and professionally with confidence, and customer service will be improved.

Recommendations corresponding to the customer information and the skill level of an operator, and sales assistance information helpful to sales can be delivered to the operator. Therefore, it is possible for any operator in any sales office to properly assist any customer, and properly provide sales information and products. This improves services for customers and consistently provides customers with a certain level of services.

The second embodiment according to the present invention will be described. Similar configuration and operation to those of the first embodiment are not be described in the following description.

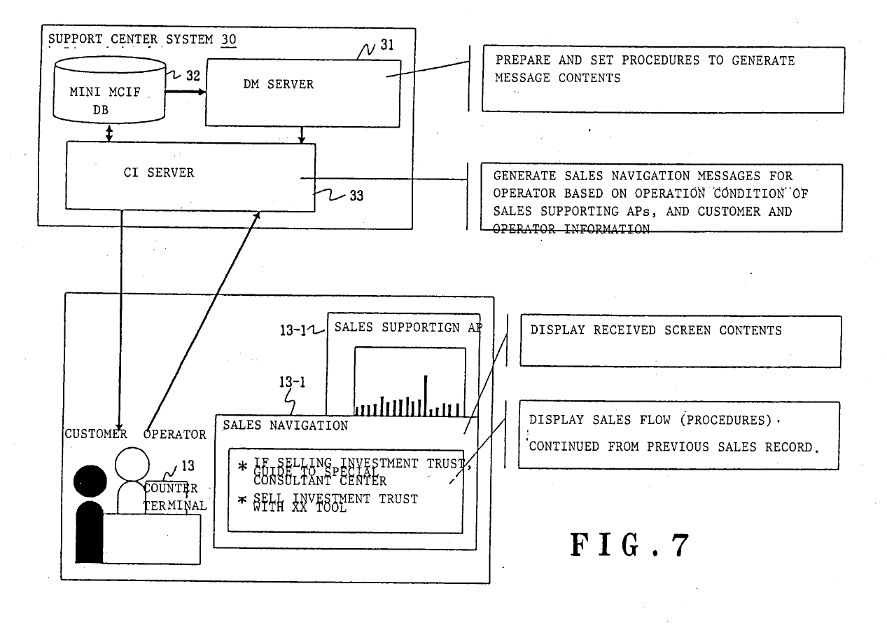

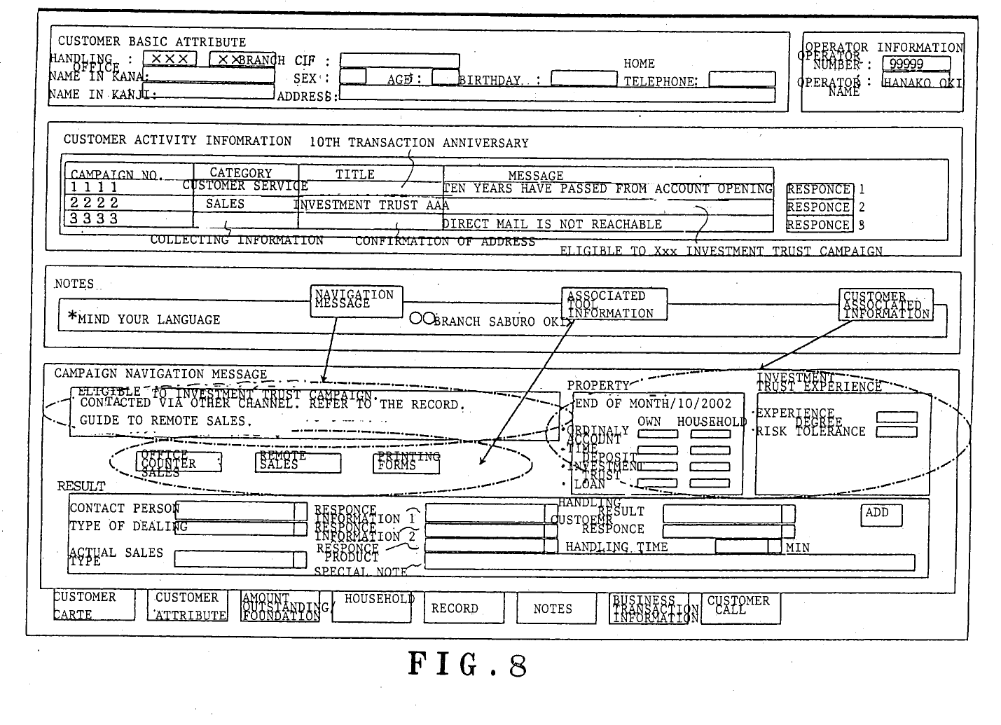

FIG. 7 shows an operation by which an operator receives advice according to the second embodiment of the present invention. FIG. 8 shows screen contents including sales assistance information according to the second embodiment of the present invention.

In this embodiment, an operator chooses an action included in the sales assistance information described in the first embodiment, and sales navigation messages are consequently displayed on the operator-dedicated screen 13-1 of the counter terminal 13.

Firstly, the operator presses a button “Response 2” to choose campaign No. 2222, which is displayed in the action-to-customer information field as shown FIG. 6B according to the first embodiment. The campaign No. 2222 is sales for an investment trust. Choice of the campaign No. 2222 is transmitted from the counter terminal 13 to the support center system 30.

Then, the CI server 33 in the support center system 30 which has access to the mini MCIF database 32, acquires campaign messages, customer information, sales action information, and a skill level of the operator, and generates screen contents including sales navigation messages to the operator according to procedures previously prepared and stored by the DM server 31.

The screen contents are transmitted to the counter terminal 13. The counter terminal 13 displays the received screen contents on the operator-dedicated screen 13-1 as shown in FIG. 7. In addition to the sales navigation messages, a graph showing the customer's cash flow can be displayed by the sales support application 16c.

The operator-dedicated screen 13-1 can also display sales assistance information as shown in FIG. 8. Beside the customer basic attribute, the action-to-customer information, and the notes as in the first embodiment, the sales assistance information includes navigation messages, associated tool information, and associated customer information corresponding to the choice of the campaign No. 2222 instead of the customer record (carte) shown in FIG. 6D. The navigation messages are messages for the operator which are necessary to promote the campaign chosen for the customer. The associated tool information are various sales assistance tools which are necessary to promote the campaign chosen for the customer. The navigation messages and the associated tool information can be chosen by pressing buttons respectively. The associated customer information is helpful (useful) to promote the campaign chosen as an action for the customer.

The CI server 33 can additionally monitor a sales achievement for the customer at the counter, generate screen contents including the most appropriate sales navigation messages corresponding to the sales situation, and transmit the screen contents to the counter terminal 13. The observation of the sales situation can be achieved by monitoring the operations of the sales support applications that are used for sales at the counter terminal 13.

In this embodiment, if an operator chooses an action included in the sales assistance information displayed in the operator-dedicated screen 13-1 of the counter terminal 13, sales navigation messages are displayed on the operator-dedicated screen 13-1. The sales navigation messages include the navigation messages, the associated tool information, and the associated customer information.

Therefore, any operator at any sales office can properly assist any customer, and provide high quality services and sales on products. Thus, services for customers can be improved.

The third embodiment according to the present invention will be described. Similar configuration and operation to those of the first or second embodiments are not described in the following description.

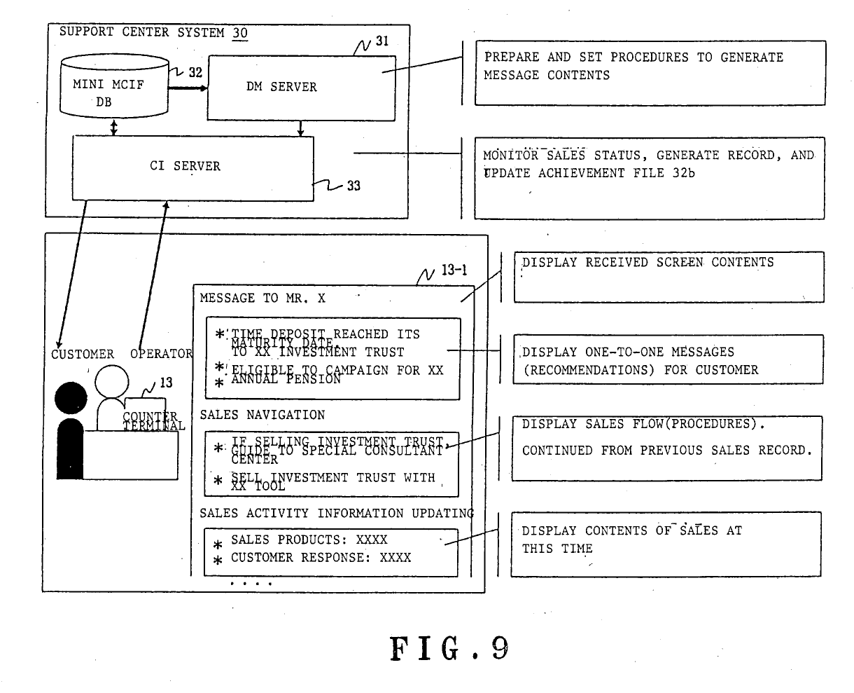

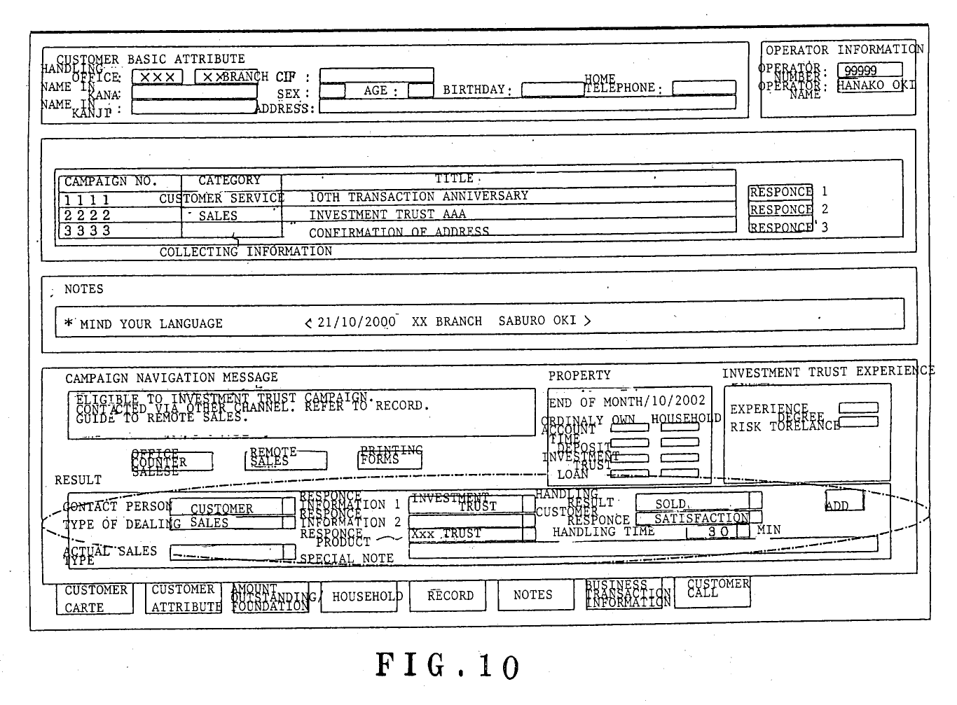

FIG. 9 shows the operation in which an operator receives advice of the third embodiment according to the present invention. FIG. 10 shows screen contents including sales assistant information in the third embodiment according to the present invention.

In this embodiment, an operator inputs a sales result according to the sales navigation messages described in the second embodiment.

An operator operates an input device (not shown) of the counter terminal 13 to input a sales result into the column of results shown in FIG. 10. After completing the input, the operator presses the “Add” button. The information input to the result column are transmitted from the counter terminal 13 to the support center system 30. Since the screen contents shown in FIG. 10 are the same as those of the second embodiment, the description is omitted.

The CI server 33 accesses the mini MCIF database 32 to update the sales action information stored in the achievement record file 32b, and the skill level of the operator stored in the operator file 32d, and/or add new information based on the received information which have been input to the result column. The CI server 33 can also update the sales action information and the skill level of the operator, and/or add new information based on the monitored result of the actual sales situation with the customer at the counter. The updated sales action information is displayed on the operator-dedicated screen 13-1 as shown in FIG. 9.

In this embodiment, an operator inputs the sales result based on the sales navigation messages. The information stored in the achievement record file 32b and the operator file 32d of the mini MICF database 32 will be updated. Thus, sales results can be promptly acquired and the sales record can be efficiently managed. Since sales navigation messages are generated based on the information stored in the achievement record file 32b and the operator file 32d, which are updated, and displayed on the operator-dedicated screen 13-1 of the counter terminal 13, the services for customers can be improved.

The fourth embodiment according to the present invention will be described. Description of the same configuration and the same operations as those of the first to third embodiments are omitted.

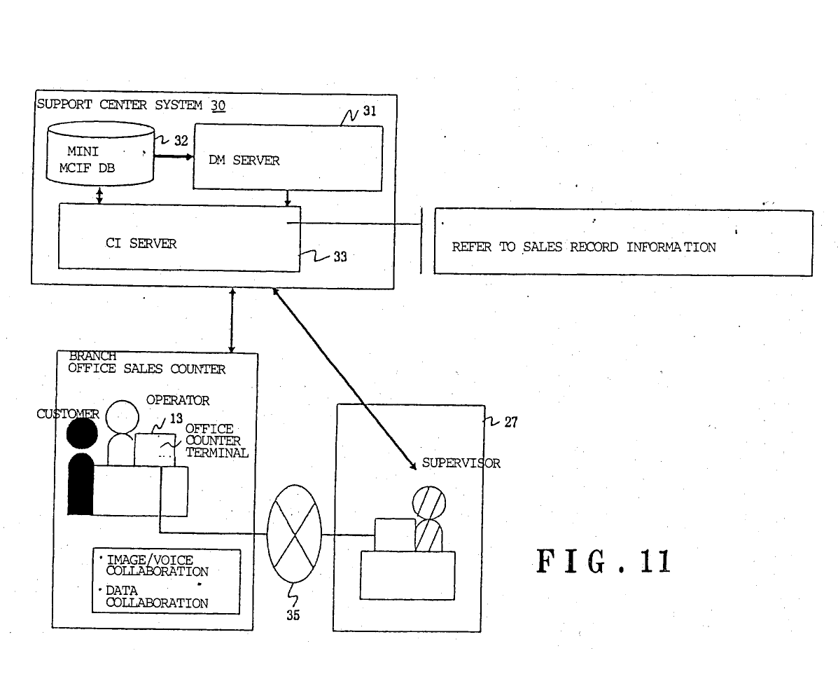

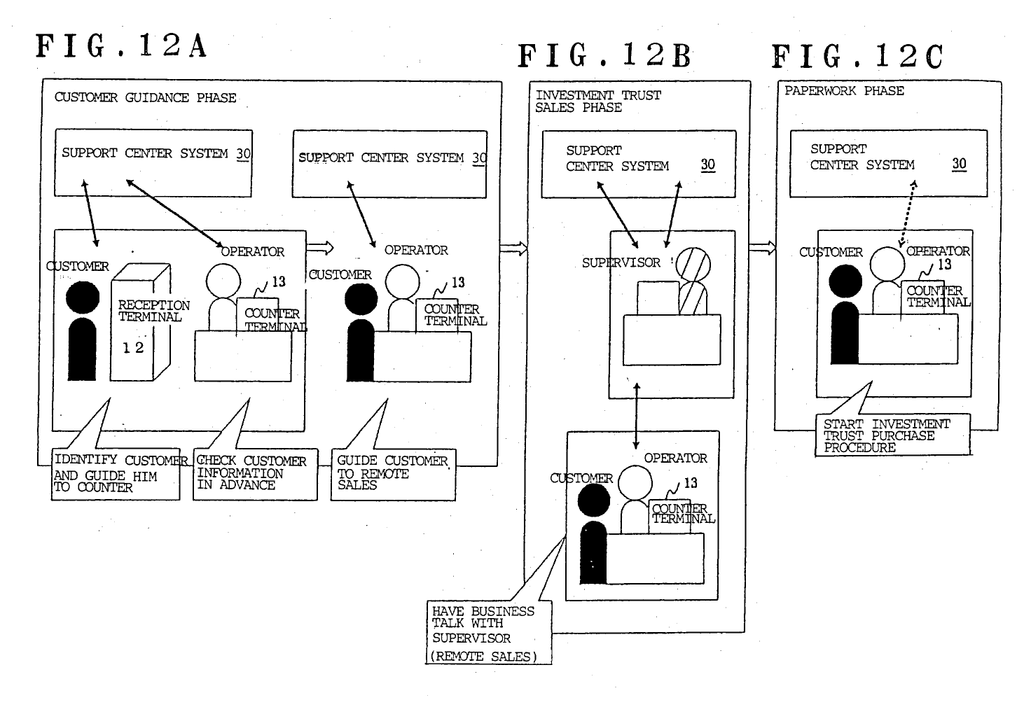

FIG. 11 shows the operation for remote sales according to the fourth embodiment of the present invention. FIGS. 12A to 12C show a series of operations including remote sales according to the fourth embodiment of the present invention.

In this embodiment, an operator chooses remote sales in accordance with the sales navigation messages described in the second embodiment. The operator follows the navigation messages shown in FIG. 8 as in the second embodiment, and decides to guide a customer to remote sales. The operator operates an input device (not shown) of the counter terminal 13 and presses a “Remote sales” button included in the associated tool information shown in FIG. 8. As shown in FIG. 11, the counter terminal 13 is connected via the network 35 to the supervisor terminal in the contact center 27.

In the customer guidance phase shown in FIG. 12A, a customer who visits a counter of a sales office operates the reception terminal 12 by himself/herself and is guided to a counter. Then, an operator assists the customer and prompts the customer to remote sales in accordance with the sales navigation messages described in the second embodiment. Here, it should be assumed that the operator sells investment trusts to the customer according to the sales navigation message.

If the counter terminal 13 is connected to a supervisor terminal in the contact center 27 and the investment trusts sales phase shown in FIG. 12B has begun, both of the counter terminal 13 and the supervisor terminal enable a teleconference and data collaboration (data sharing). The common screen 13-2 of the counter terminal 13 displays an image of the supervisor 13-2b in the contact center 27 and the sales for the customer is promoted by conducting a teleconference. In this case, as the customer can also watch the common screen 13-2, the supervisor can display the materials 13-2a such as data, graphs and tables for the explanation to the customer. The supervisor can promote sales by viewing necessary information such as the customer basic attribute, the action-to-customer information, and the customer associated information.

After the investment trust explanation phase ends, if the customer decides to buy an investment trust, the paperwork phase shown in FIG. 12C begins, and the operator inputs necessary information by interviewing the customer into the counter terminal 13 so as to conduct a sales procedure. In this case, the sales result is also input as in the third embodiment, and the CI server 33 accesses the mini MCIF database 32 so as to update the sales action information stored in the achievement record file 32b and/or the information on the skill level of the operator stored in the operator file 32d, or add new information, based on the input information.

In this embodiment, a customer is guided to remote sales, in which the customer is prompted to buy by a supervisor with expert knowledge and experiences about services and products offered by the financial institute. Therefore, every sales office can provide specialized services to a customer, and services for a customer are improved.

The financial institute can handle sales on diversified and upgraded products without allocating a supervisor for specialized sales in each branch office.

The fifth embodiment according to the present invention will be described. Similar configuration and operation to those of the first to the fourth embodiments are not be described in the following description.

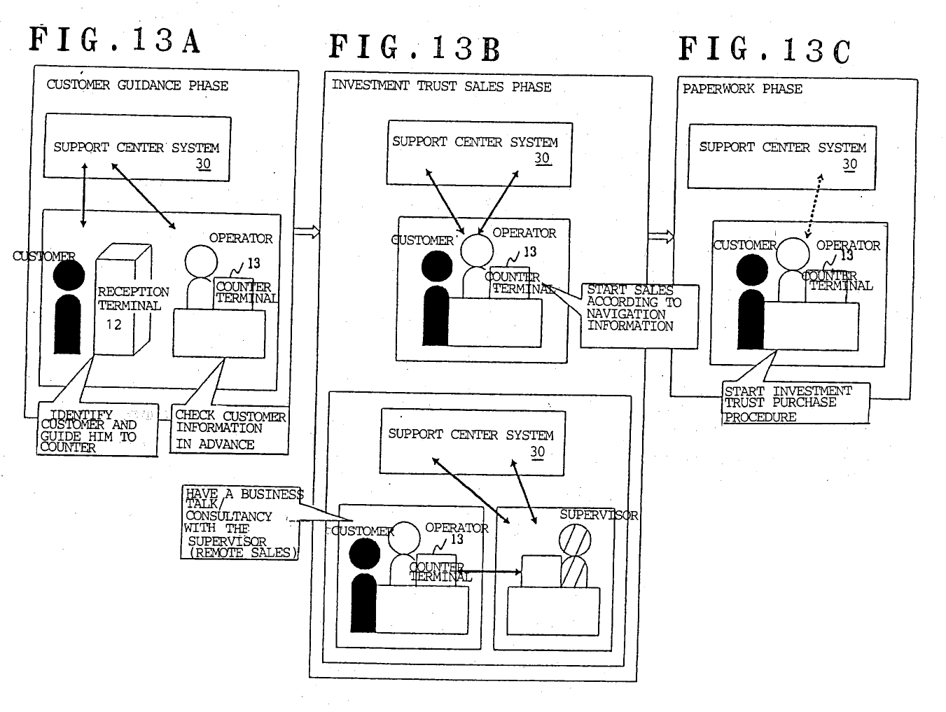

FIGS. 13A to 13C show a series of operations including remote sales according to the fifth embodiment of the present invention.

Unlike the fourth embodiment, an operator mainly makes sales in the investment trusts sales phase described in the forth embodiment, and if the operator needs help of a supervisor, the operator can ask for help such as advice and remote sales.

In the investment trusts sales phase shown in FIG. 13B, the operator sells investment trusts according to the navigation messages displayed on the operator-dedicated screen 13-1. If inquiries from a customer are very special or detailed, and the operator decides that it is difficult for the operator to reply to the inquiries, the operator presses a “Remote sales” button included in the associated tool information shown in FIG. 8, which connects the counter terminal 13 with the super visor terminal in the contact center 27. Then, as described in the fourth embodiment, the supervisor can make a sales to the customer and provide explanations with viewing necessary information such as customer basic attribute, action-to-customer information, and customer associated information.

The customer guidance phase shown in FIG. 13A and the paperwork phase shown in FIG. 13C, which are the same as those of the fourth embodiment, are not described in the following description.

In this embodiment, an operator mainly makes sales and can get assistance from a supervisor if needed. Thus, a supervisor can be efficiently counted on and the whole system can be efficiently operated.

The sixth embodiment according to the present invention will be described. Similar configuration and operation to those of the first to fifth embodiments are not described in the following description.

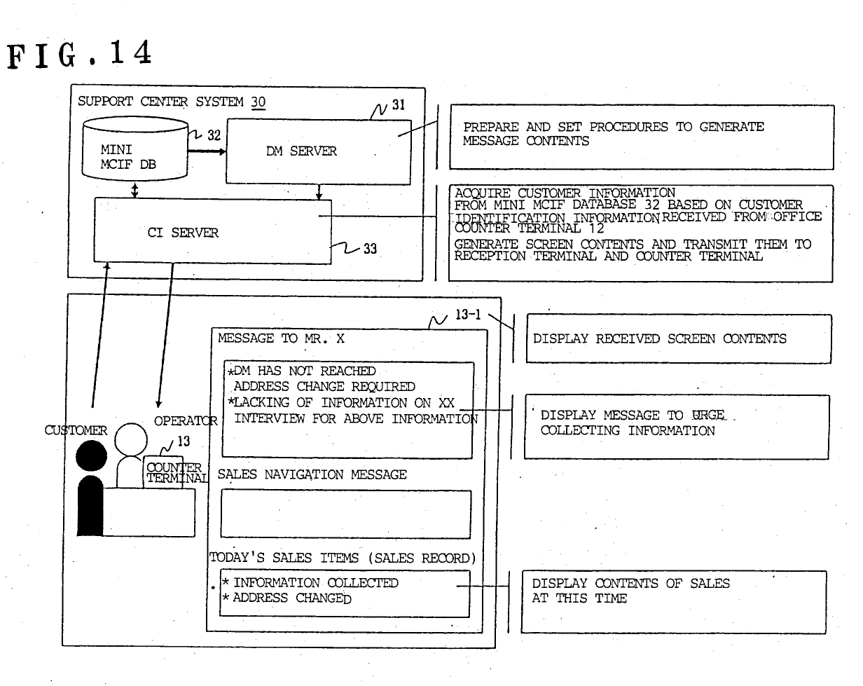

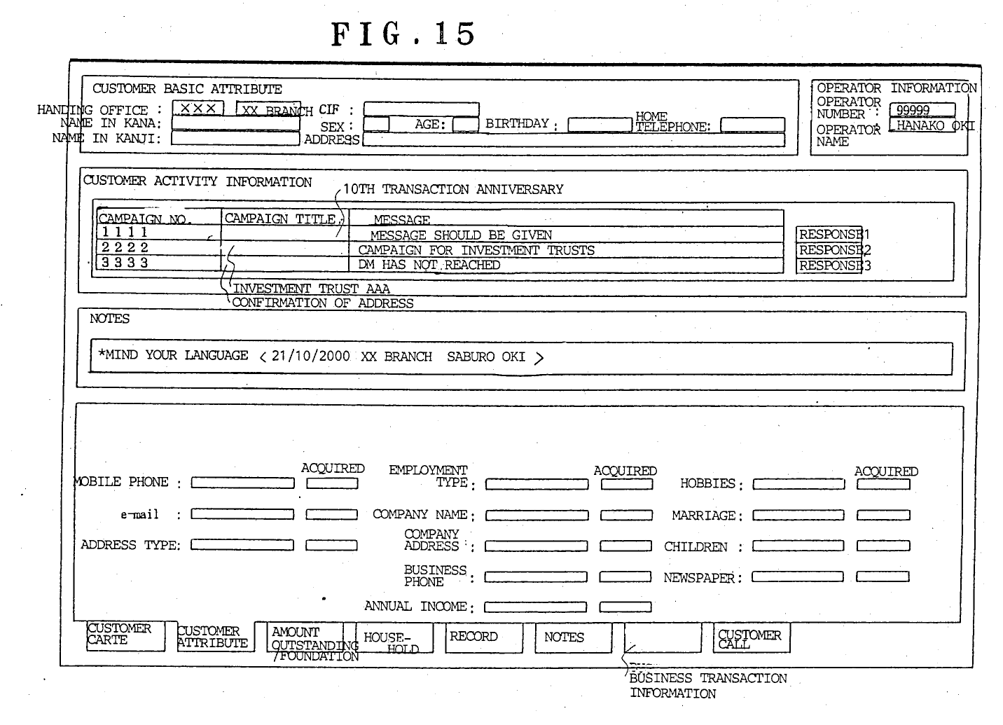

FIG. 14 shows an operation in which an operator receives advice according to the sixth embodiment of the present invention. FIG. 15 shows screen contents including sales assistance information according to the sixth embodiment of the present invention.

In this embodiment, an operator selects an action included in the sales assistant information of the first embodiment, and inputs missing items for the customer attribute information on the operator-dedicated screen 13-1 of the counter terminal 13.

The operator presses a “Response 3” button in order to choose campaign No. 3333 displayed in the action-to-customer information field shown in FIG. 6B in the first embodiment. The campaign No. 3333 relates to collecting information and more specifically confirmation of a customer's address. Choice of the campaign No. 3333 is transmitted from the counter terminal 13 to the support center system 30.

The CI server 33 in the support center system 30 accesses the mini MICF database 33, acquires the campaign messages and the customer information, and generates screen contents to collect information according to the procedure previously prepared and set in the DM server 31.

The screen contents are transmitted to the counter terminal 13. The counter terminal 13, as shown in FIG. 14, displays the received screen contents on the operator-dedicated screen 13-1. The message to confirm the customer's address is displayed.

The operator-dedicated screen 13-1 can also display the sales assistance information as shown in FIG. 15. In addition to the customer basic attribute, action-to-customer information, and notes as in FIG. 6 of the first embodiment, the sales assistance information includes an input column for the customer attribute corresponding to the choice of the campaign No. 3333 instead of the customer record (Carte) shown in FIG. 6D.

The operator confirms the customer's address and operates an input device (not shown) to input the confirmed address into the input column of the customer attribute shown in FIG. 15. After the operator completes the input, the “Update” button is pressed. The items which have been input to the input columns of the customer attribute are transmitted to the support center system 30.

The CI server 33 accesses the mini MCIF database 32 to update the customer basic attribute information stored in the CIF 32a and the customer attribute information stored in the actual sales record file 32b based on the received items which have been input to the input columns of the customer attribute.

In this embodiment, information directly acquired from a customer is input to a counter terminal by an operator. This information updates the information stored in the CIF 32a of the mini MCIF database 32 and the actual sales record file 32b. Since the sales navigation messages are generated based on the updated information, services for a customer can be improved. Additionally, collection of information can be efficiently implemented.

The seventh embodiment according to the present invention will be described. Similar configuration and operation to those of the first to sixth embodiments are not described in the following description.

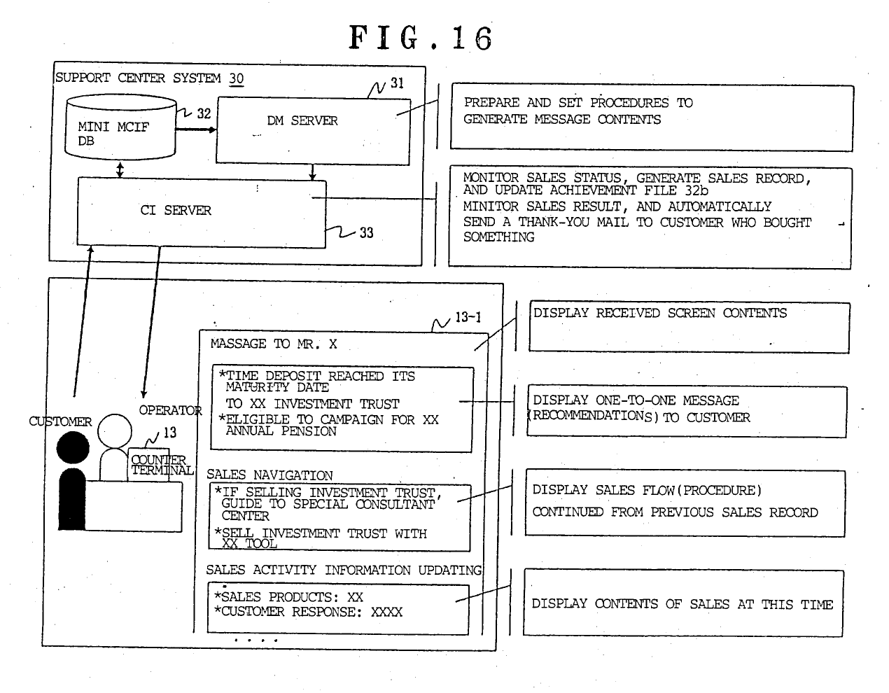

FIG. 16 shows an operation in which an operator receives advice according to the seventh embodiment of the present invention.

In this embodiment, if sales of a product are successfully achieved, a thank-you note is automatically sent to the customer by electronic mail, facsimile, telephone, or mail.

As in the third embodiment, an operator inputs the sales result. The CI server 33 accesses the mini MCIF database 32 to update the sales achievement information stored in the actual sales record file 32b and the information on the skill level of the operator stored in the operator file 32d, and/or add new information, based on the received items (data) which are input to the result column.

The CI server 33 also generates a thank-you message based on the sales result, and transmits the thank-you message by electronic mail to the customer's electronic mail address included in the customer basic attribute information stored in the CIF 32a. If the customer basic attribute information does not include an electronic mail address, a thank-you message will be sent to the customer by facsimile, telephone, or mail.

In this embodiment, according to the sales result, follow-ups for a customer such as appreciation is automatically implemented and then customer services are effectively achieved.

The eighth embodiment according to the present invention will be described. Similar configuration and operation to those of the first to seventh embodiments are not described in the following description.

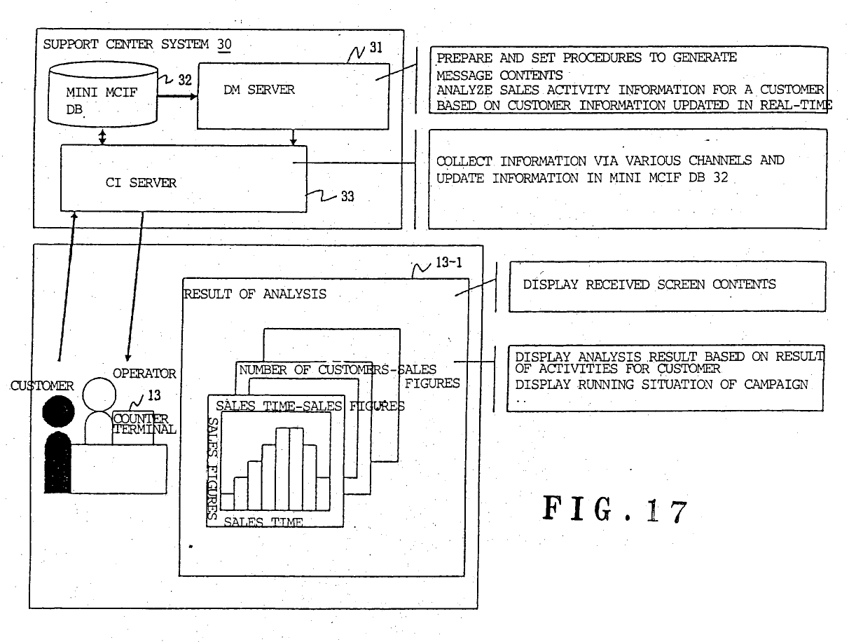

FIG. 17 shows an operation in which an operator receives advice according to the eighth embodiment of the present invention.

In this embodiment, analysis based on the sales action information updated in the third embodiment is displayed on the operator-dedicated screen 13-1 of the counter terminal 13.

As in the third embodiment, an operator inputs the sales result. The CI server 33 accesses the mini MCIF database 32 to update the sales action information stored in the actual sales record file 32b and/or add new information, based on the received items which are input to the result column. The DM server 31 gathers sales action information, which is updated or added, in real-time to analyze the sales action information.

If a request for the analysis result is transmitted from the counter terminal 13 to the support center system 30, the CI server 33 generates screen contents including the analysis result generated by the DM server 31. The counter terminal 13, as shown in FIG. 17, displays the received screen contents on the operator-dedicated screen 13-1. A bar chart showing the relation between sales period and sales quantity is displayed.

In this embodiment, the counter terminal 13, the resultant analysis of information such as sales action information in real-time, and the efficiency of customer sales and current campaigns will be improved.

The ninth embodiment will be described. Similar configuration and operation to those of the first to eighth embodiments are not described in the following description.

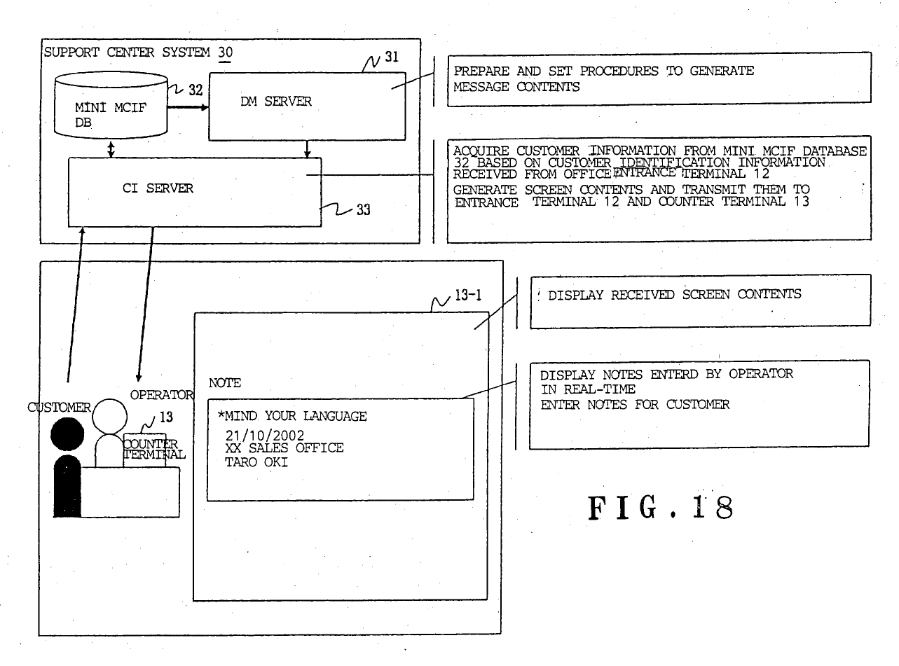

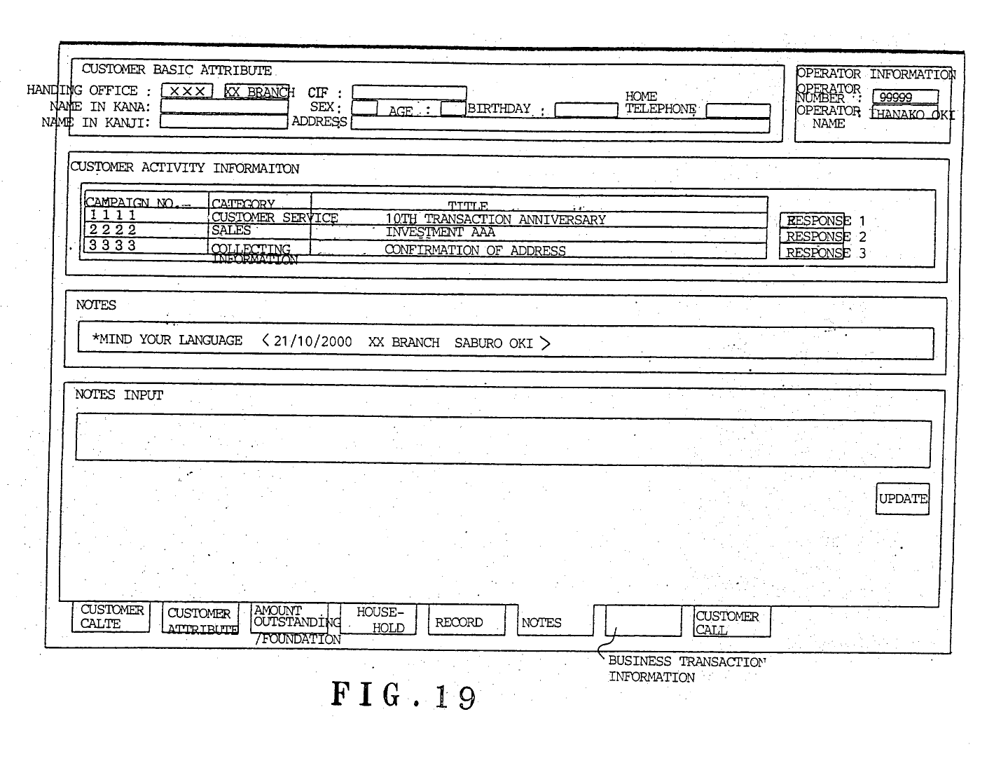

FIG. 18 shows an operation in which an operator receives advice according to ninth embodiment of the present invention. FIG. 19 shows screen contents including sales assistance information according to the ninth embodiment of the present invention.

In this embodiment, an operator inputs or updates the notes described in the first embodiment.

The operator chooses and clicks a “notes” tag to display an input column for notes in place of the customer record (carte) shown in FIG. 6D in the first embodiment. Choice of “notes” is transmitted from the counter terminal 13 to the support center system 30.

The CI server 30 in the support center system generates screen contents to input the notes, and the screen contents are transmitted to the counter terminal 13. The counter terminal 13 displays the received screen contents on the operator-dedicated screen 13-1 as shown in FIG. 18. The notes that have already been input are displayed.

The operator-dedicated screen 13-1 displays the sales assistance information shown in FIG. 19. In addition to the customer basic attribute information, the action-to-customer information, and the notes as in FIG. 6 of the first embodiment, the sales assistance information includes input columns for notes instead of the customer record (carte) shown in FIG. 6D.

An operator operates the input device (not shown) of the counter terminal 13 to input notes about the customer to the input column of the notes shown in FIG. 19. After the operator completes the input, the operator presses the “Update” button. The items which have been input in the input column of the notes are transmitted from the counter terminal 13 to the support center system 30.

The CI server 33 accesses the mini MCIF database 32 to update the customer attribute information stored in the achievement record file 32b based on the received items which are input to the input column of the notes.

In this embodiment, an operator inputs notes on a customer, which updates the information stored in the achievement record file 32b of the mini MCIF database 32. Since the sales navigation messages are generated based on the updated information and enable all operators to share the notes related to the customer, services for the customer can be improved. Further, information is efficiently collected.

The tenth embodiment according to the present invention will be described. Similar configuration and operation to those of the first to ninth embodiments are not described the following description.

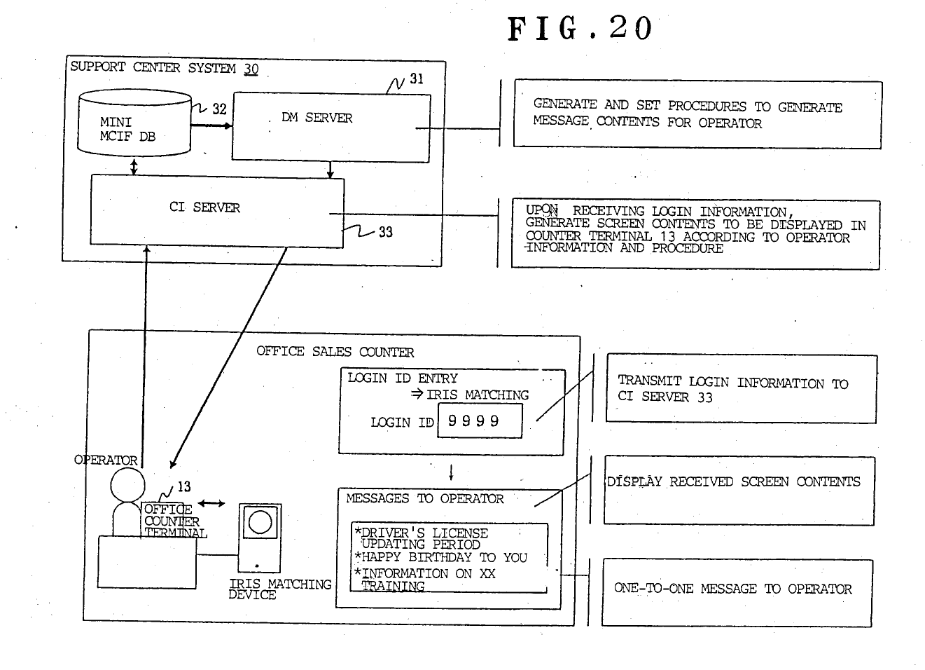

FIG. 20 shows an operation in which an operator logs onto the CI server according to the ninth embodiment of the present invention.

As shown in FIG. 20, if an operator uses the counter terminal 13, the operator inputs a login ID and is personally authenticated by an iris collator (personal verifier) connected to the counter terminal 13. The iris verifier conducts personal authentication based on iris patterns i.e. biometrics information.

Then, the counter terminal 13 transmits the login information such as a terminal ID and an operator ID to the support center system 30. The CI server 33 of the support center system 30 accesses the mini MCIF database 32 to acquire the operator attribute information stored in the operator file 32d based on the received information. Based on the acquired operator attribute information, the CI server 33 generates screen contents including CI server-to-operator messages for the operator according to the procedure previously prepared and set in the DM server 31. The screen contents are transmitted to the counter terminal 13.

The counter terminal 13 displays the received screen contents on the operator-dedicated screen 13-1.

If the operator's birthday, driver's license updating date, wedding anniversary, and family information are managed (stored) in the operator attribute information stored in the operator file 32d, messages personalized for each operator based on the operator attribute information can be sent.

In this embodiment, when messages or directions for the operator who logs on are displayed on the operator-dedicated screen 13-1, individual messages or directions can be timely sent to the operator. Thus, it is expected that the operator is motivated and the work efficiency will be improved.

The present invention is not limited to the above embodiments, and various changes and modifications can be made based on the purpose(s) of the invention. These changes and modifications are included within the scope of the present invention.

According to the present invention, office counter work supporting information, which is generated based on various information collected via multiple channels, can be properly provided to an operator to support the operator at an office counter work station.

What is claimed is:

1. An office counter work supporting system comprising;
an sales office system including a counter terminal operated by an operator; and
a support center system including a database to store information collected from multiple channels and a server to generate office counter work supporting information based on the information stored in said database, the support center being connected via a network to said office system.

2. The office counter work supporting system according to claim 1, wherein said office system has a reception terminal operated by a customer, and said support center system generates a message used to guide said customer, and transmits the message to the reception terminal so that the reception terminal displays the message.

3. The office counter work supporting system according to claim 1, wherein said support center system generates office counter work supporting information based on information received from said counter terminal, and transmits the office counter work supporting information to said counter terminal so that said counter terminal displays the office counter work supporting information.

4. The office counter work supporting system according to claim 1, wherein said network is connected with a contact center, and said support center system connects said contact center to said counter terminal in accordance with information received from said counter terminal.

5. The office counter work supporting system according to claims 1, wherein said multiple channels include said counter terminal, said reception terminal, a call center connected to the network and a contact center connected to said network.

6. The office counter work supporting system according to claim 1, wherein said information stored in said database includes customer attribute information, sales action information for the customer, and operator attribute information.

7. The office counter work supporting system according to claim 6, wherein said server generates said office counter work supporting information in accordance with said customer attribute information, said sales action information for said customer, or said operator attribute information.

8. A database for a support center system,
wherein said support center system is connected via a network to an office system, and the office system includes a counter terminal operated by an operator, and
wherein said database stores first information to generate office counter work supporting information and second information collected from multiple channels.

9. The database for a support center system according to claim 8, wherein said information includes customer attribute information, sales action information for a customer information, and operator attribute information.

10. The database for a support center system according to claim 8, wherein said multiple channels include said counter terminal, a reception terminal, a call center connected to the network and a contact center connected to the network.

11. A counter terminal included in an office system connected to a support center system, wherein said support center system includes a database to store information collected from multiple channels and a server to generate office counter work supporting information based on said information stored in said database, and
wherein said counter terminal is operated by an operator to receive and display said office counter work supporting information.
